(19) United States
(12) Patent Application Publication
(10) Pub. No.: US 2013/0336225 A1
(43) Pub. Date: Dec. 19, 2013

(54) METHOD AND APPARATUS FOR TRANSMITTING A NETWORK IDENTITY

(71) Applicants: Miikka Juhana Poikselka, Espoo (FI); Alexander Milinski, Munchen (DE)

(72) Inventors: Miikka Juhana Poikselka, Espoo (FI); Alexander Milinski, Munchen (DE)

(73) Assignee: NOKIA SIEMENS NETWORKS OY, Espoo (FI)

(21) Appl. No.: 13/997,887

(22) PCT Filed: Nov. 3, 2011
(86) PCT No.: PCT/EP11/69279

§ 371 Date: Jun. 25, 2013

(30) Foreign Application Priority Data
Dec. 31, 2010 (EP) 2010/070951

(51) Int. Cl. H04W 8/04

(52) U.S. Cl. CPC H04W 8/04
USPC 370/328; 455/432.1

(57) ABSTRACT

The invention relates to a session control entity, method and computer program for receiving an indication indicating a network where an access network entity for a user is located, transmitting a message for establishing a session for the user, and, including the indication indicating the network in the message.

### TECHNICAL FIELD OF THE INVENTION

The present invention relates to a mechanism for transmitting a network identity. In particular, the present invention is related to a method and apparatus for transmitting network where an access network entity for a user is located.

### BACKGROUND OF THE INVENTION

Within the IP (Internet Protocol) Multimedia Subsystem (IMS) as defined by 3^{rd} Generation Partnership Project (3GPP) Session Initiation Protocol (SIP) defined by the Internet Engineering Task Force (IETF) is used for controlling communication. SIP is an application-layer control protocol for creating, modifying, and terminating sessions with one or more participants. These sessions may include Internet multimedia conferences, Internet telephone calls, and multimedia distribution. Members in a session can communicate via multicast or via a mesh of unicast relations, or a combination of these. Session Description Protocol (SDP) is a protocol which conveys information about media streams in multimedia sessions to allow the recipients of a session description to participate in the session. The SDP offers and answers can be carried in SIP messages. Diameter protocol has been defined by IETF and is intended to provide an Authentication, Authorization and Accounting (AAA) framework for applications such as network access or IP mobility.

Generally, for properly establishing and handling a communication connection between network elements such as a user equipment and another communication equipment or user equipment, a database, a server, etc., one or more intermediate network elements such as control network elements, support nodes, service nodes and interworking elements are involved which may belong to different communication networks.

Traditionally in the circuit switched (CS) domain many operators may be involved in terminating a call from a calling party to a called party. Every operator wants to receive its share of costs billed from the calling party. Call detail records (CDR) are generated by involved network nodes to collect information for charging and billing. Operators can compare and exchange CDRs in a clearing process to balance the costs. To have all relevant information available in CDRs for the clearing process, certain information has to be exchanged within call signalling between operators during a call setup.

The 3GPP has specified different options for IMS roaming and GSM Association (GSMA) has endorsed one of those options for long-term evolution (LTE) IMS (voice over IP) VolP roaming. In the selected option, a proxy call session control function (P-CSCF) and packet data network (PDN) gateway (GVV) or gateway GPRS support node (GGSN) of the visited communication service provider are used.

There exist demand to maintain roaming charging feature parity between the CS and the IMS domains.

### SUMMARY OF THE INVENTION

The present invention can overcome some of above drawbacks by providing an apparatus, a method and a computer program product comprising receiving an indication indicating a network where an access network entity for a user is located, transmitting a message for establishing a session for the user, and, including the indication indicating the network in the message.

The receiving can comprise receiving the indication during registration procedure of the user, and/or the indication can comprise an inter-operator identifier (101).

The access network entity can comprise a proxy call session control function of the user.

The message for establishing the session can comprise a request or a response according to session initiating protocol (SIP).

The apparatus, method and computer program product can comprise including, in the message, network type information associated with the indication indicating the network. The network type information can indicate that the indicated network comprises the network where the access network entity for the user is located, and/or, the network type information can indicate whether the access network entity is located in an originating access network or in a terminating access network.

The network type information can comprise:
a value of an inter-operator identifier (101) type, for example, Value 4, or,
a parameter in a P-Charging-Vector header, for example “pcscf-orig-ioi” or “pcscf-term-ioi”.

Further, an apparatus, a method and a computer program product are provided, comprising receiving a message for establishing a session between a first user and a second user, wherein the message comprises an indication indicating a network where an access network entity for the first user is located.

The apparatus, method and computer program product can comprise participating in registration procedure of the second user, for example, handling a SIP REGISTER request.

The message for establishing the session can comprise a request or a response according to session initiating protocol (SIP), and/or, the indication can comprise an inter-operator identifier (IOI).

The access network entity can comprise a proxy call state control function of the first user.

Further, an apparatus, a method and a computer program product are provided receiving a message for establishing a session for a user, including, in the message, an indication indicating the network where the proxy call session control function is located, and forwarding the message.

The apparatus, method and computer program product can comprise including in the message network type information associated with the indication indicating the network, and, the network type information can indicate that the indicated network comprises the network where the proxy call session control function is located.

The network type information can comprise:
a value of an inter-operator identifier (IOI) type, for example, Value 4, or,
a parameter in a P-Charging-Vector header, for example “pcscf-orig-ioi” or “pcscf-term-ioi”.

Embodiments of the present invention may have one or more of following advantages:
_P-CSCF and S-CSCF become able to create CDRs which can contain information about the far end serving and/or visited networks and feature parity to CS voice roaming charging can thereby be maintained.
All needed information can be generated in CDRs to enable operators to find out afterwards which other operators have been involved in IMS session made by a subscriber.
P-CSCF is able to provide the same information to a charging entity than a visited mobile switching center (MSC) can provide for CS calls.

### DESCRIPTION OF DRAWINGS

FIG. 1 illustrates network elements and signaling between network elements relevant for the invention.

FIGS. 2 and 4 illustrate example signaling flows according to aspects of the invention.

FIGS. 3a and 3b illustrate information made available in network elements according to aspects of the invention.

FIG. 5 illustrates example of internal structure and functions of apparatus implementing aspects of the invention.

### DETAILED DESCRIPTION OF THE INVENTION

Different types of network entities and functions exist in the IMS network. Call Session Control Functions (CSCF) implement a session control function in SIP layer. The CSCF can act as Proxy CSCF (P-CSCF), Serving CSCF (S-CSCF) or Interrogating CSCF (I-CSCF).

The P-CSCF is the first SIP level contact point for User Equipment (UE) within the IMS, for example, during IMS registration procedure and when handling session related signaling. The P-CSCF can be located in a visited network when the UE is roaming.

The I-CSCF is mainly the contact point within an operator's network for all IMS connections destined to a subscriber of that network operator, or a roaming subscriber currently located within that network operator's service area. The functions performed by the I-CSCF are, for example, assigning an S-CSCF to a user performing a SIP registration and routing SIP requests received from another network towards the S-CSCF.

The S-CSCF handles the session states in the network. The S-CSCF can perform the session control services for the UE. It maintains a session state as needed by the network operator for support of the services and may be acting as Registrar, i.e. it accepts registration requests and makes its information available through the location server (e.g. HSS). The S-CSCF is the central point to users that are hosted by this S-CSCF. The S-CSCF can provide services to registered and unregistered users when it is assigned to these users. This assignment can be stored in the Home Subscriber Server (HSS). The S-CSCF can be located in the home network of a user also when the user is roaming.

The HSS is the master database for a given user. It is the entity containing the subscription-related information to support the network entities actually handling calls/sessions. As an example, the HSS provides support to the call control servers (CSCFs) in order to complete the routing/roaming procedures by solving authentication, authorisation, naming/addressing resolution, location dependencies, etc.

The HSS can be responsible for holding the following user related information:
User identification, numbering and addressing information, including a display name.
User security information: Network access control information for authentication and authorization, such as password information
User Location information at inter-system level: the HSS supports the user registration, and stores inter-system location information, etc.
User profile information.

In an IMS registration with a CSCF, user equipment (UE) registers itself to a CSCF for a specific time, and the CSCF becomes the UE's serving CSCF (S-CSCF). The time for which the UE is registered in the S-CSCF is called registration lifetime. Re-registration is a procedure where the UE refreshes its registration to the network before the registration expires.

Inter-operator identifier (IOI) is globally unique identifier that can be shared between operator networks, service providers, and content providers, to be used, for example, as charging correlation information with offline and online charging.

An end-to-end IMS session may traverse networks of several operators. To allow operators involved in the session signaling (SIP) to identify each other, the IOI can be exchanged between the operators within the SIP signalling. The IOI can consist of one pair of originating IOI and terminating IOI.

One purpose of the IOI concept is to allow operators to uniquely identify each other for the SIP based requests, for example, to enable correct charging and billing of end users. The IOI can be transmitted between a home public land mobile network (HPLMN) of a calling user and a HPLMN of a called user, or, between a HPLMN of a calling user and a visited public land mobile network (VPLMN) of the called user.

The IOI can be used for inter operator accounting identification purposes and the IOI concept can be applied on a peer to peer basis between operators.

IOI identities can be included within SIP signaling, for example, a P-Charging-Vector parameter. For example, when a SIP request is leaving an originating network the IOI identity of that originating network can be included in the SIP signaling, and, when a SIP response is returned the IOI identity of the responding (terminating) network can be included in the SIP signalling.

Three types of IOI have been defined:
Type 1 IOI is used between a home network operator of a user and a visited network operator for the user in roaming situation, if a P-CSCF for the user is located in the visited network. Type 1 IOI can be transmitted in REGISTER requests and responses. The P-CSCF can be responsible for generating the originating IOI of type 1 and the S-CSCF in the home network can be responsible for generating the terminating IOI of type 1.
Type 2 IOI is used between a network operator which can hold a subscription of the originating user and a network operator which can hold a subscription of the terminating user. The S-CSCF in the originating user's home network can be responsible for generating the originating IOI of type 2 and the S-CSCF in the terminating user's home network can be responsible for generating the terminating IOI of type 2. Type 2 IOI can be transmitted in an INVITE request and a response.
Type 3 IOI is used between a home network operator of a user and a service provider. When forwarding a request to an AS, the S-CSCF in the home network can generate the originating IOI of type 3. The AS contacted by the S-CSCF can be responsible for generating the terminating IOI of type 3.

For type 1 and type 3 10Is, a generating SIP entity can express the “orig-ioi” and “term-ioi” header field parameters, for example, in the format of a quoted string with a specific string prefix being “Type 1” and “Type 3” respectively to indicate the type of IOI. For the type 2 IOI, no string prefix is used.

IOI received in session signalling can be stored locally an can be incorporated into charging data records (CDR) generated by IMS network elements

The P-Charging-Vector header can be used to transmit charging related information, such as the globally unique IMS charging identifier (ICID) value and IOIs. When a CSCF receives a SIP request that does not contain a P-Charging-Vector header, the CSCF may insert it with charging parameters available at the CSCF. A CSCF that receives a SIP request that contains a P-Charging-Vector header can use the information to produce charging records.

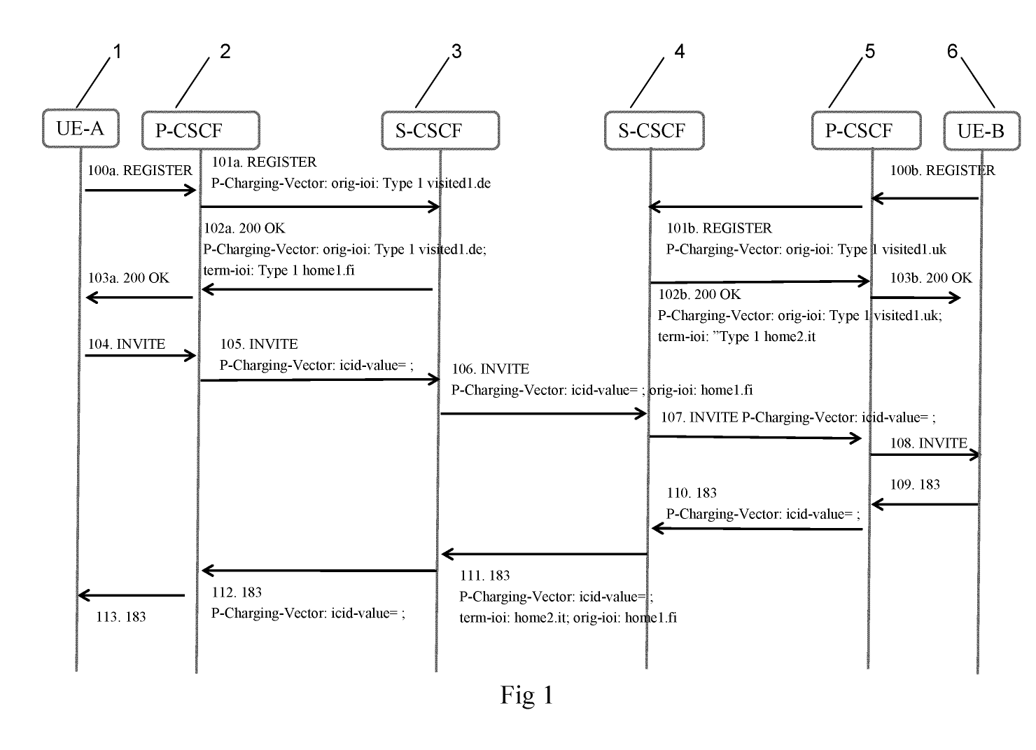

FIG. 1 illustrates procedures for transmitting IOIs during registration and session setup. P-Charging-Vector parameter can contain inter-operator identifier (IOI) which can contains information about involved operators. In 100a, a user 1 is transmitting a registration request (SIP REGISTER) towards the IMS. A P-CSCF 2 is the first SIP level contact point for the user 1 in the IMS. In 101a, the P-CSCF 2 forwards the registration request to an S-CSCF 3 which is allocated to serve the user 1 according to IMS registration and S-CSCF assignment procedures. The P-CSCF 2 can be located in a visited IMS network and can include in the registration request, an IOI of Type 1 identifying the visited IMS network of the P-CSCF 2, in this example, orig-IOI: Type 1visited1.de

An S-CSCF 3 receives the registration request 101a and can perform registration related actions not shown in the figure. The S-CSCF 3 can acknowledge the registration with a response 102a (e.g. 200 OK SIP response) to the P-CSCF 2. In the response 102a, the S-CSCF can in turn include its own IOI of type 1, which is the IOI identifying a home network of the user 1, because the S-CSCF 3 is located in the home network of the user 1. In this example, term-IOI: Type 1 home1.fi is included by the S-CSCF 3. The P-CSCF 2 shall remove IOIs from the response before transmitting the response 103a to the user 1.

Messages 100b-103b illustrate corresponding registration procedure for another user 6, which is currently located in a visited network “visited1.uk” and is having a home network “home2.it”.

Further network elements, for example an I-CSCF, can be located between the network entities shown in FIG. 1. Procedures towards an HSS during the registration are not shown.

In 104, the user 1 is establishing a session towards the user 6 by transmitting, for example, a SIP INVITE message. The P-CSCF 2 does not include any IOI in the request when forwarding 105 the message to the S-CSCF 3. The S-CSCF 3 can include orig IOI type-2 into the request, in this example orig-IOI: home1.fi, when transmitting the request 106 towards an IMS network of the called user 6. An S-CSCF 4 can store the received IOI and shall remove any received IOI before forwarding the request 107 to a P-CSCF 5 of the user 6, which in turn, can forward the request 108 to the user 6.

In 109 the user 6 transmits a response, for example, a SIP 183 response message, to the

P-CSCF 5, which can forward the response to the S-CSCF 4. The S-CSCF 4 can include, into the response 111, the term-IOI type-2, as well as, the orig-IOI as received in the corresponding INVITE 106.

The S-CSCF 3 receives the IOI information in the response 111, can store it and shall remove any IOIs before forwarding the response 112 to the P-CSCF 2. The P-CSCF 2 can forward the response 113 to the user 1.

At the moment, the visited P-CSCF 2 does not learn which network is serving and terminating the called party (IOI of S-CSCF 4 and IOI of P-CSCF 5) and the P-CSCF 2 is not able to insert this type of information into IMS CDR. This means that charging records created in the IMS do not include as much information as CDRs in the CS side. Enabling similar flexibility in both CS and IMS domain charging would require that a P-CSCF is able to provide the same information to a charging entity than a visited mobile switching center (MSC) can provide for CS calls.

According to an aspect of the invention, inter operator identifier (IOI) handling is extended to make IOIs available in relevant IMS entities.

According to an aspect of the invention, newly defined IOIs can be made available in the IMS entities.

According to an aspect of the invention, an S-CSCF shall not remove IOI(s) towards a P-CSCF. According to an aspect of the invention, an S-CSCF shall not remove IOI(s) towards a P-CSCF only inside a trusted domain.

According to an aspect of the invention, an S-CSCF can insert into an outgoing SIP request an IOI which the S-CSCF has learned from a P-CSCF during registration of a user. According to an aspect of the invention, the S-CSCF can insert the IOI learned from the P-CSCF during the registration into the outgoing SIP request only when the outgoing SIP request is sent towards another network and/or operator (having different IOI).

According to an aspect of the invention, behavior of a P-CSCF can be extended to store and understand IOIs, also IOIs of other types than “Type 1”

According to an aspect of the invention, a new IOI type can be defined, in addition to current types: Type 1, Type 2 and Type 3. For example, Type 4 could be defined as: “Type 4 IOI: IOI of the network where the P-CSCF is located”

According to an aspect of the invention, a new parameter or parameters can be defined, for example, for P-Charging-Vector header to convey information about the network where visited P-CSCF is located. The parameter(s) could be called for instance “pcscf-orig-ioi” and “pcscf-term-ioi”

According to an aspect of the invention, behavior of a P-CSCF can be extended to include a new type of IOI or new parameter in a SIP INVITE Request or in an appropriate SIP Response.

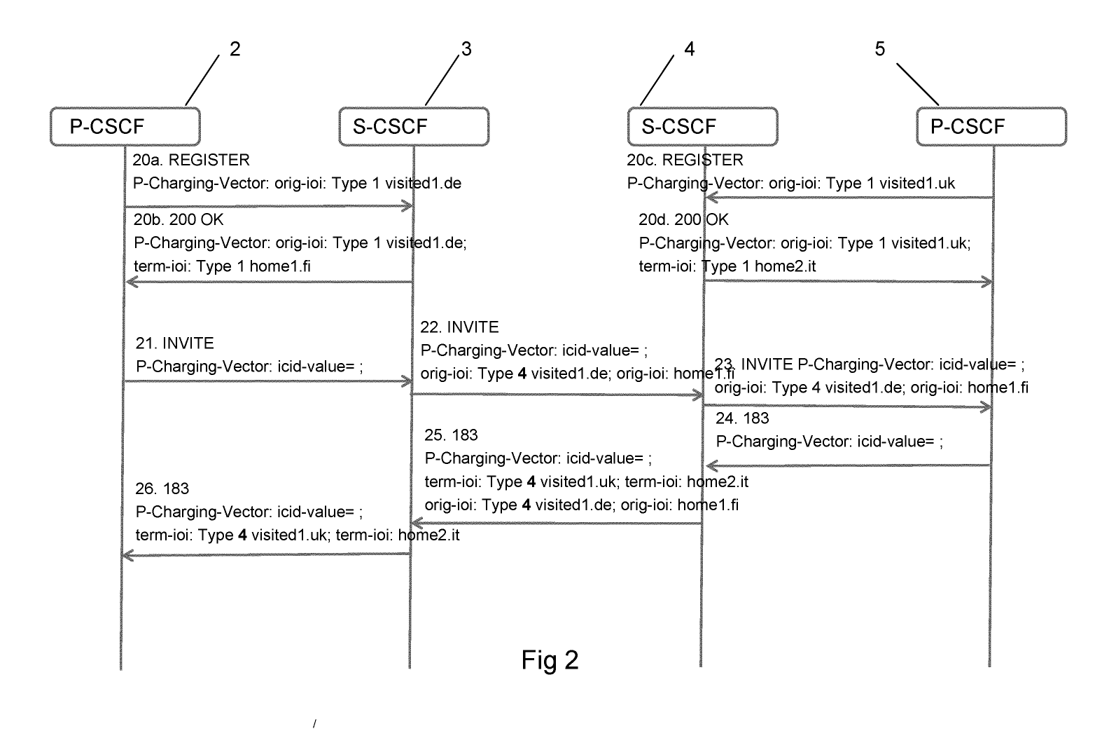

FIG. 2 shows an example of the invention. For simplicity, a calling party (UE 1 in FIG. 1) and a called party (UE 6 in FIG. 1) and signaling to/from UEs is not shown. In steps 20a-20d the calling party and the called party register to their IMS networks (to S-CSCF via P-CSCF), as explained with FIG. 1.

First, a calling party is transmitting an INVITE request to establish a session with a called party. A P-CSCF 2 transmits the INVITE 21 to an S-CSCF 3 in the home network of the calling party.

According to an aspect of the invention, the S-CSCF 3 can include an identity, for example an IOI, of the network and/or operator where the P-CSCF of the calling party is located in the INVITE request when forwarding the INVITE. The S-CSCF can use orig-ioi value (orig-ioi: Type 1 visited1.de) obtained from the P-CSCF 2 (during registration of the calling party 20a) and/or can convert it into a different format for the outgoing INVITE 22. The S-CSCF 3 can include more than one identity, for example, also an identity of the home network and/or operator, where the S-CSCF 3 can be located. For one or more identities the S-CSCF 3 can attach/include additional information which can indicate the nature/type of the identity, for example, if the network and/or operator indicated by the IOI is a home network of the calling party where the S-CSCF 3 is located or if the network and/or operator indicated by the IOI is the network where the calling party and/or the P-CSCF 2 is currently located. In the example of FIG. 2, IOI Type 4 is used to indicate the IOI of the P-CSCF 2. IOI of Type 1 obtained from the P-CSCF 2 can be converted into IOI of Type 4 for an outgoing INVITE.

The S-CSCF 3 can send the INVITE request 22 towards a home network of the called party. The INVITE can now contain two “orig-ioi” parameters, instead of one orig-ioi parameter as shown in FIG. 1. The S-CSCF 4 can receive the INVITE request 22 and can store information from the INVITE into a memory of the S-CSCF 4. The stored information, such as 101s, can later be used for generating CDRs.

According to an aspect of the invention, the S-CSCF 4 can forward the INVITE request 23 with orig-ioi parameter(s) to a P-CSCF 5, instead of removing the orig-ioi parameter(s) from the INVITE as shown in FIG. 1.

The P-CSCF 5 can receive a response to INVITE request from the called user, for example, a 183 SIP response, and can forward the response 24 to the S-CSCF 4.

According to an aspect of the invention, prior to forwarding the response, the S-CSCF 4 can include identities, for example of IOIs, of the home network/operator of the called party and of the network/operator where the called party and/or P-CSCF 5 is located in the response. This addition/including can be done following the same logic as explained above in relation to the S-CSCF 3, for example, by using the orig-ioi “Type 1 visited1.uk” obtained from the P-CSCF 5 during registration 20c of the called party. The S-CSCF can attach/include additional information which can indicate the nature/type of the identity, for example, if the network and/or operator indicated by the IOI is a home network of the called party where the S-CSCF 4 is located or if the network and/or operator indicated by the IOI is the network where the called party and/or the P-CSCF 5 is currently located.

The S-CSCF 4 can send the 183 SIP response 25 to the S-CSCF 3 and the response can now contain two term-ioi parameters instead of one term-ioi parameter as shown in FIG. 1. The S-CSCF 3 receives the 183 response and can store information, such as IOIs, from the response into a local memory, for example, to be used later in CDR generation.

According to an aspect of the invention, the S-CSCF 3 can forward the response with term-ioi parameter(s) to the P-CSCF 2, instead of removing term-ioi parameter(s) as shown in FIG. 1.

According to an aspect of the invention, the P-CSCF 2 and the P-CSCF 5 can store information, such as any received IOIs, from a SIP request/response into a local memory, for example, to be used later in CDR generation.

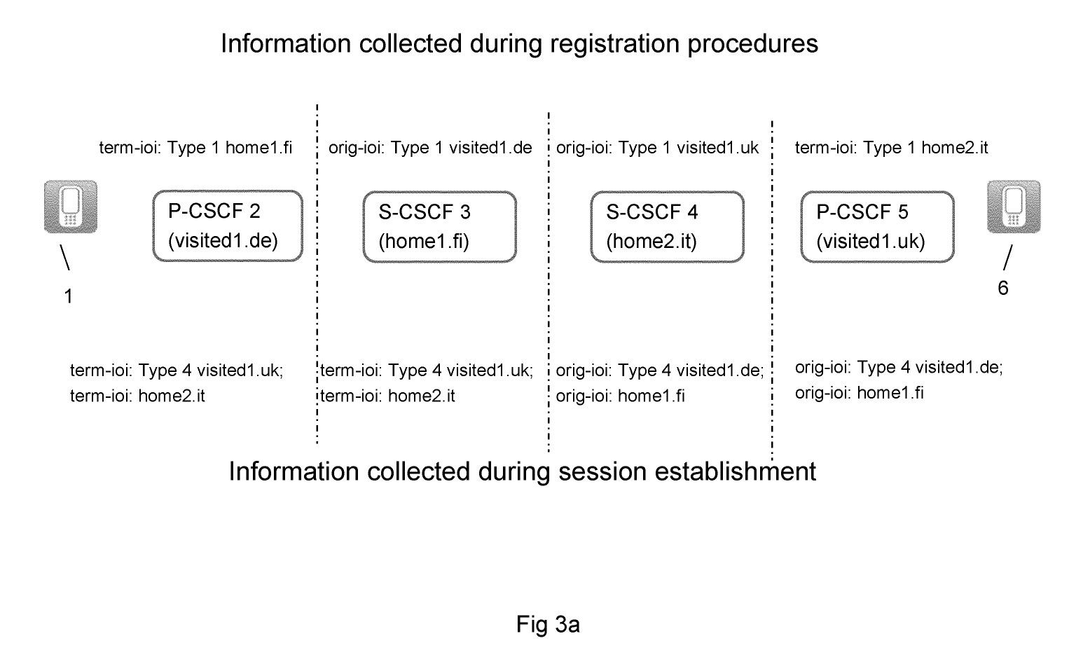

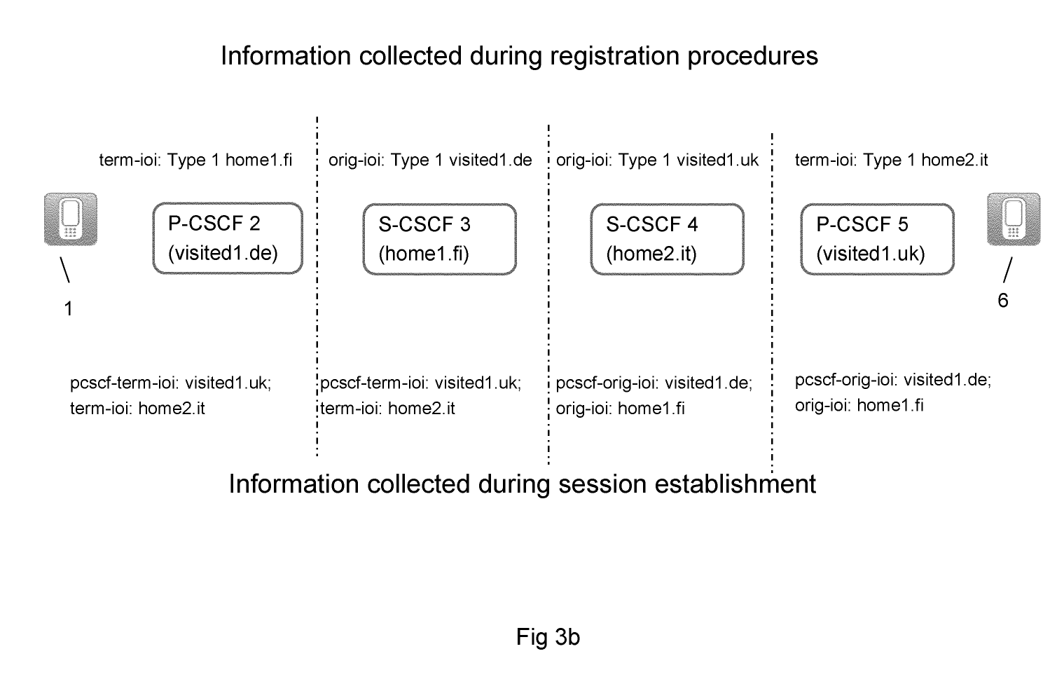

FIGS. 3a and 3b show an overview of IOIs available in each relevant network entity according to some aspects of the invention. In the example of FIG. 3a, a new IOI type is illustrated (as already explained with FIG. 2) and in the example of FIG. 3b a new parameter for IOI is illustrated. Four P/S-CSCFs can be involved in the signalling path. For every CSCF the network where the CSCF in question is located is shown in brackets under the name of the CSCF, for example, P-CSCF 2 is located in “visited1.de” and so on. In the upper part of FIGS. 3a and 3b it is shown which IOIs can be stored by various CSCFs already during registration procedures of calling user 1 and called user 6. In the bottom part of FIGS. 3a and 3b it is shown which IOIs can be stored by various CSCFs during establishment of a session between the calling and called users. As can be seen in FIG. 3a, for example, the (visited) P-CSCF 2 can have knowledge of new Type 4 IOI of a (visited) network (P-CSCF 5) of the called party 6, and, can also know the IOI of the home network (S-CSCF 4) of the called party 6. Based on this information the visited P-CSCF is able to create CDRs which can contain information about the far end networks and feature parity to CS voice roaming charging can be maintained.

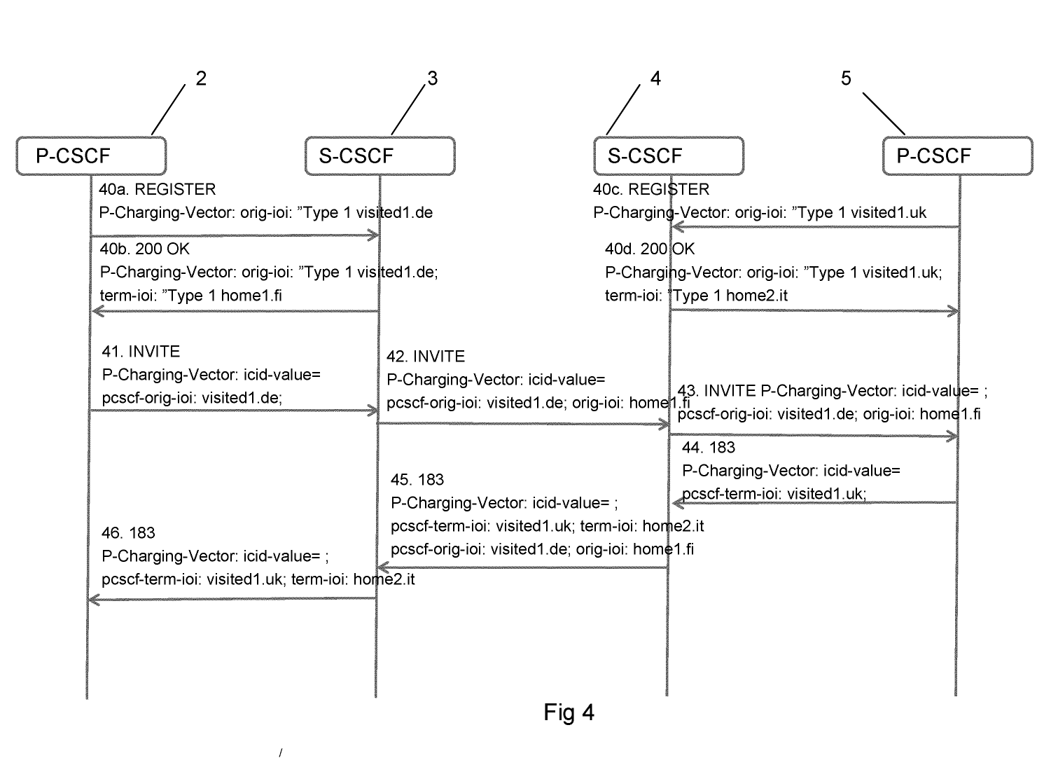

FIG. 4 shows alternative embodiment of the invention. In the embodiment of FIG. 2, the S-CSCF was responsible to include P-CSCF's IOI value into a P-Charging-Vector header as learned from SIP registration. Alternatively the P-CSCF itself could include the IOI when a session is being established. Instead of using “Type 4” IOI as shown in FIGS. 2 and 3a, FIG. 4 also shows an alternative SIP protocol enhancement option. Steps 40a-40d, corresponds to what is explained before in relation to steps 100-103 of FIG. 1. A P-CSCF 2 can receive an INVITE request from a calling user. Prior forwarding the request to a S-CSCF 3, the P-CSCF can add pcscf-orig-ioi parameter identifying itself (network/operator of the P-CSCF 2). The S-CSCF 3 can receive the INVITE request 41 and can add its own ioi-parameter prior forwarding the request 42 to a S-CSCF 4. The S-CSCF 4 can receive the INVITE request 42 and can forward the INVITE 43 with pcscf-orig-ioi and orig-ioi parameters to a P-CSCF 5, instead of removing such parameters as shown in FIG. 1.

The P-CSCF 5 can receive a 183 response from a called user and, prior forwarding 44 the response to the S-CSCF 4, the P-CSCF 5 can add pcscf-term-ioi parameter identifying itself (network/operator of the P-CSCF 5). The S-CSCF 4 can receive the 183 response 44 and can add its own ioi-parameter prior forwarding the response 45 to the S-CSCF 3. The S-CSCF 3 can receive the 183 response 45 and can forwards the response with pcscf-term-ioi and term-ioi parameters to the P-CSCF 2 instead of removing such parameters as shown in FIG. 1. According to the embodiment of FIG. 4, all relevant CSCFs can become aware of necessary IOIs as shown in FIG. 3b.

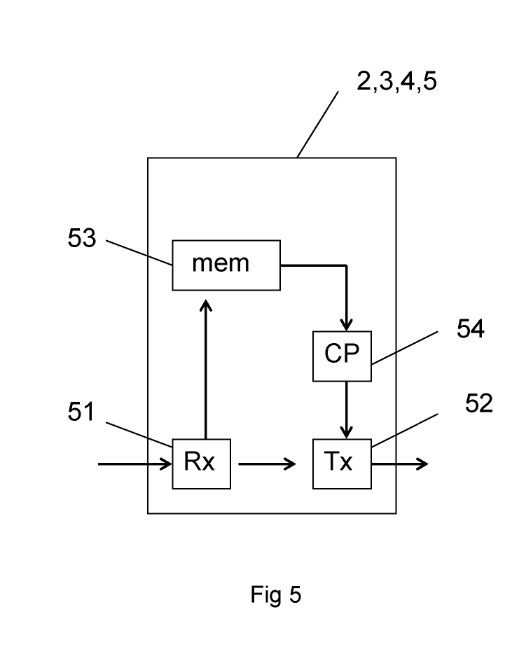

FIG. 5 illustrates example of internal structure and functions of apparatus, for example a CSCF (P-CSCF/S-CSCF), implementing aspects of the invention. The apparatus can have a receiving unit (receiver) 51 which can be configured to receive signaling messages, for example, according to SIP. The receiving unit 51 can receive requests (INVITE, REGISTER) and responses (200 OK, 183) and can examine signaling messages and store information from the received messages into a memory unit (memory) 53. For example, information indicating an operator/network (IOI) can be stored from a message into the memory 53, together with the information of type of the operator/network (IOI). The information stored in the memory unit 53 can be associated with a user and/or a session to which the information relates to. The memory unit 53 can be configured to store an identity of an operator/network to which the apparatus itself belongs to, for example, as an IOI. A transmitting unit (transmitter) 52 can be configured to transmit signaling messages, for example, according to SIP. The transmitting unit 52 can transmit requests (INVITE, REGISTER) and responses (200 OK, 183) and can transmit (forward) signaling messages received by the receiving unit 51. A processor unit (processor) 54 can be configured to modify signalling messages to be sent by the transmitting unit 52 before sending, for example, using the information (e.g. IOIs) stored in the memory unit 53 and which the processor unit 54 can retrieve. The processor unit 54 can be configured to include information relating to one or more operators/networks, for example, as an IOI into a signaling message to be transmitted. For example, the processor unit 54 can include the apparatus' own operator/network identity in a signaling message, for example, in a SIP REGISTER or INVITE request or in SIP 183 or 200 responses. The processor unit 54 can be configured to convert information relating to operator/network identity before including into a signaling message, for example, IOI Type 1 can be converted into a specific new value (e.g. IOI Type 4) or into a new parameter indicating that the IOI relates to a network, possible to a visited network, where the user is currently located/roaming.

All units described above in relation to FIG. 5 may be implemented for example using microprocessors, chips and/or other electrical components and/or by software.

An apparatus, for example a session control entity (CSCF), implementing aspects of the invention may be physically implemented in a switch, router, server or other hardware platform or electronic equipment which can support data transmission and processing tasks, or can be implemented as a component of other existing device.

In the examples described above, up to four different networks and/or operators have been involved in the session path, since is has been assumed that a calling party and a called party are subscribers to different operators (user 1: “home1.fi” and user 6: “home2.it”) and that both the calling party and the called party are currently roaming outside their home networks (user 1 in “visited1.de” and user 6 in “visited1.uk”). However, the aspects of the invention can apply also when one or both users (calling/called party) are located in their home networks (not roaming), and/or, when both the calling party and the called party are subscribers to the same operator and thereby have the same home network (S-CSCF 3 and S-CSCF 4 can have the same IOI). Also in those cases a network/operator identity (IOI), possible with a type, can included in signaling messages, transmitted between network elements ands stored by network elements.

For the purpose of the present invention as described herein above, it should be noted that
an access technology via which signaling is transferred to and from a network element or node may be any technology by means of which a node can access an access network (e.g. via a base station or generally an access node). Any present or future technology, such as WLAN (Wireless Local Access Network), VViMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer;
method steps likely to be implemented as software code portions and being run using a processor at a network element or terminal (as examples of devices, apparatuses and/or modules thereof, or as examples of entities including apparatuses and/or modules thereof), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

The invention is not limited to transmitting network identity in the IMS network(s), but may also be applied in other type of networks having similar kind of multi-operator architecture and support for multi-operator charging and is using network identity which can identify specific network or operator. Functions of the session control entity described above may be implemented by code means, as software, and loaded into memory of a computer.

1. An apparatus, comprising
means for receiving an indication indicating a network where an access network entity for a user is located,
means for transmitting a message for establishing a session for the user, and,
means for including the indication indicating the network in the message.

2. An apparatus of claim 1, wherein the means for receiving is configured to receive the indication during registration procedure of the user.

3. An apparatus of claim 1, wherein the indication comprises an inter-operator identifier (IOI).

4. An apparatus of claim 1, wherein the access network entity comprises a proxy call session control function of the user.

5. An apparatus of claim 1, wherein the message for establishing the session comprises a request or a response according to session initiating protocol (SIP).

6. An apparatus of claim 1, further comprising, means for including, in the message, network type information associated with the indication indicating the network.

7. An apparatus of claim 6, wherein the network type information indicates that the indicated network comprises the network where the access network entity for the user is located.

8. An apparatus of claim 6, wherein the network type information indicates whether the access network entity is located in an originating access network or in a terminating access network.

9. An apparatus of claim 6, wherein the network type information comprises one of:
a value of an inter-operator identifier (IOI) type, or,
a parameter in a P-Charging-Vector header (“pcscf-orig-ioi”, “pcscf-term-ioi”).

10. An apparatus comprising:
means for receiving a message for establishing a session between a first user and a second user, wherein the message comprises an indication indicating a network where an access network entity for the first user is located.

11. An apparatus of claim 10, further comprising means for participating in registration procedure of the second user.

12. An apparatus of claim 10, wherein the message for establishing the session comprises a request or a response according to session initiating protocol (SIP).

13. An apparatus of claim 10, wherein the indication comprises an inter-operator identifier (IOI).

14. An apparatus of claim 10, wherein the access network entity comprises a proxy call state control function of the first user.

15. A method, comprising
receiving an indication indicating a network where an access network entity for a user is located,
transmitting a message for establishing a session for the user, and,
including the indication indicating the network in the message.

16. A method of claim 15, wherein the receiving comprises receiving the indication during registration procedure of the user.

17. A method of claim 15, wherein the indication comprises an inter-operator identifier (IOI).

18. A method of claim 15, wherein the access network entity comprises a proxy call session control function of the user.

19. A method of claim 15, wherein the message for establishing the session comprises a request or a response according to session initiating protocol (SIP).

20. A method of claim 15, further comprising including, in the message, network type information associated with the indication indicating the network.

21. A method of claim 20, wherein the network type information indicates that the indicated network comprises the network where the access network entity for the user is located.

22. A method of claim 20, wherein the network type information indicates whether the access network entity is located in an originating access network or in a terminating access network.

23. A method of claim 20, wherein the network type information comprises one of:
a value of an inter-operator identifier (IOI) type, or,
a parameter in a P-Charging-Vector header (“pcscf-orig-ioi”, “pcscf-term-ioi”).

24. A computer program product comprising code means adapted to produce steps of claim 15 when loaded into the memory of a computer.

25. A proxy call session control function in an internet protocol multimedia subsystem (IMS), comprising
means for receiving a message for establishing a session for a user,
means for including, in the message, an indication indicating the network where the proxy call session control function is located, and
means for forwarding the message.

26. A proxy call session control function of claim 25, further comprising means for including in the message network type information associated with the indication indicating the network, and, wherein the network type information indicates that the indicated network comprises the network where the proxy call session control function is located.

27. A proxy call session control function of claim 26, wherein the network type information comprises one of:
a value of an inter-operator identifier (IOI) type, or,
a parameter in a P-Charging-Vector header (“pcscf-orig-ioi”, “pcscf-term-ioi”).
